(19) United States
(12) Patent Application Publication
(10) Pub. No.: US 2026/0314626 A1
(43) Pub. Date: Oct. 15, 2026

(54) ALCOHOL INFUSED CHOCOLATE FOOD PRODUCT

(71) Applicant: Carol Fitzgerald, Dundee, NY (US)

(72) Inventor: Carol Fitzgerald, Dundee, NY (US)

(21) Appl. No.: 19/639,847

(22) Filed: Apr. 6, 2026

Related U.S. Application Data
(60) Provisional application No. 63/789,144, filed on Apr. 15, 2025.

(51) Int. Cl. A23G 1/46; A23G 1/48; A23G 1/56

(52) U.S. Cl. CPC A23G 1/46; A23G 1/48; A23G 1/56

(57) ABSTRACT

A method of making a chocolate food product includes preparing a chocolate base comprising chocolate and milk; maintaining the chocolate base at a first temperature between about 100 °F and about 120 °F while stirring; adding an alcohol to the chocolate base while maintaining the first temperature; and incorporating an alcohol within the chocolate base while maintaining the first temperature to form the alcohol infused chocolate food product.

### TECHNICAL FIELD

The present invention relates generally to chocolate, more specifically to chocolate infused with alcohol, and still more particularly to a method for producing a chocolate infused with alcohol wherein the final food product has an alcohol-by-volume percentage greater than two percent.

### BACKGROUND

Infusing alcohol into a finalized chocolate food product presents many challenges. For example, temperature control is needed to prevent scorching of the chocolate while also preventing evaporation of the alcohol from the final product. Additionally, the hydrophobic constituents of the chocolate create difficulties when trying to incorporate the hydrophilic hydroxyl group on the alcohol within the chocolate. That is, care must be taken to avoid phase separation during manufacture and during long-term storage of the final product.

Therefore, there is a need for a method for producing an alcohol infused chocolate food product that is shelf-stable, preferably long-term, without spoilage or phase separation of the alcohol and chocolate constituents.

### BRIEF SUMMARY OF THE INVENTION

With parenthetical reference to corresponding parts, portions, steps or elements of the disclosed embodiment, merely for the purposes of illustration and not by way of limitation, the present invention provides an alcohol infused composition and a method for producing same.

In exemplary embodiments of the present invention, a method of making a chocolate food product includes preparing a chocolate base comprising chocolate, vanilla, and milk; maintaining the chocolate base at a first temperature between about 100 °F and about 120 °F while stirring; adding an alcohol to the chocolate base while maintaining the first temperature; and incorporating the alcohol within the chocolate base while maintaining the first temperature to form the alcohol infused chocolate food product.

Exemplary embodiments of the present invention may further be directed to a method of making an alcohol-infused chocolate food product comprising preparing a chocolate base including chocolate and milk and maintaining the chocolate base at a first temperature between about 100 °F and about 120 °F while stirring, followed by adding an alcohol to the chocolate base while maintaining the first temperature. The alcohol is blended, via an immersion blender, within the chocolate base while maintaining the first temperature until the alcohol is incorporated within the chocolate base without phase separation of the alcohol. The blended alcohol and chocolate base is then stirred to form the alcohol-infused chocolate food product while maintaining the first temperature. The alcohol-infused chocolate food product is dispensed into a container and allowed to cool to room temperature. The cooled alcohol-infused chocolate food product has a water activity less than 0.85 and a viscosity greater than about 150,000 centipoise (cps), and the container is configured for shelf storage of at least six months.

These and other objects and advantages of the method of making a chocolate food product will be readily appreciated from the following description of various embodiments.

### DETAILED DESCRIPTION OF THE EMBODIMENTS

While the composition and method for an alcohol-infused food product is described with respect to what are presently considered to be certain preferred aspects, it is to be understood that the disclosure is not intended to be limited to the disclosed aspects. Applicant contemplates that many changes and modifications may be made. Therefore, while an embodiment of the composition and method has been shown and described, and a number of alternatives discussed, persons skilled in this art will readily appreciate that various additional changes and modifications may be made without departing from the spirit of the disclosure.

Furthermore, this disclosure is not limited to the particular methodologies, materials and modifications described and as such may, of course, vary. It is also understood that the terminology used herein is for the purpose of describing particular aspects only, and is not intended to limit the scope of the applicant's invention(s).

In an exemplary embodiment of the invention, a method of making a chocolate food product may generally include an initial step of preparing a chocolate base comprising chocolate, vanilla and milk. To prepare the chocolate base, a clean, dry, and sanitized production kettle is heated to between about 90 °F and about 95 °F. While any suitable vessel may be used, one preferred vessel is a jacketed stainless-steel kettle holding jacketed water to help control temperature stability. The kettle is equipped with an agitator with variable speed controls to facilitate mixing and stirring of the added ingredients. It is further noted that care must be taken to control moisture during preparation of the alcohol infused chocolate food product. Accordingly, all equipment should be clean, dry and sanitized immediately prior to use as any extraneous water may negatively impact the texture and stability of the final product.

Once the kettle is heated to temperature, milk is added to the kettle and stirred to avoid scorching. As used herein, the term “milk” may be any dairy or non-dairy milk, cream, or similar substance or substitute. In one aspect, the milk may be one or more of whole milk, cream, evaporated milk, dried milk, or sweetened condensed milk, and in a preferred embodiment is sweetened condensed milk (SCM). Non-diary milk may also be used, such as but not limited to one or more of oat milk, soy milk, cashew milk, almond milk, rice milk, coconut milk, or pea milk. The milk may also be a combination of dairy and non-dairy milks. It is noted that, if SCM or another sweetened milk is not used, sugar may be added to the milk and the temperature of the milk may be raised to at least 145 °F for at least 30 minutes, or to 161 °F for 15 seconds, to pasteurize the milk and kill bacteria. If the milk undergoes pasteurization, the milk needs to be cooled to the working temperature of between about 100 °F and about 120 °F before proceeding. It is further noted that SCM is thicker than non-condensed milk and is more shelf stable. In one aspect of the invention, using SCM helps to lower the water activity in the final alcohol infused chocolate food product, thereby promoting shelf stability of the final product without risk of bacterial growth.

Once the milk is to temperature between about 100 °F and about 120 °F, flavoring ingredients may be added to the milk. In an exemplary embodiment, salt and vanilla may be added. The salt may enhance the sweetness of the final food product and may be any desired salt, such as but not limited to pink Himalayan salt, sea salt or kosher salt. The vanilla may be one or more of a real vanilla, including an extract, powder, or paste thereof, and an artificial vanilla extract, powder, or paste, and is preferably real vanilla powder. To complete the chocolate base, chocolate is slowly added to the kettle with continual stirring of the contents.

It is conceived that any acceptable chocolate may be used, including but not limited to dark chocolate, milk chocolate, semi-sweet chocolate, white chocolate, ruby chocolate, blonde chocolate, gianuja chocolate, chocolate liquor, and combinations thereof, whether in solid, liquid or powder form. In one exemplary embodiment the total cocoa solids (cocoa butter and cacao) within the chocolate is at least 50%, and more preferably between about 50% and about 85%, and still more particularly between about 55% and about 60%. It is noted that chocolate with a high cocoa content provides for improved heat stability and heat resistance during manufacture of the final food product. This improved heat stability and heat resistance may assist in maintaining the structure of the chocolate to form a creamy final food product and avoiding a grainy texture. It is further noted that white chocolate does not include cacao solids/nibs such that the sole contributor to the total cocoa solids is the cocoa butter, wherein the cocoa butter comprises at least 20%, and more preferably at least about 25% of the white chocolate. Once all of the chocolate has been added, the chocolate base is stirred until reaching a smooth consistency and a maintained temperature between about 100 °F and about 120 °F.

While maintaining the chocolate base at a temperature between about 100 °F and about 120 °F with stirring, the alcohol is slowly added. Any type of alcohol may be used, including but not limited to a spirit (whiskey, vodka, tequila, cordial, rum, gin, brandy, etc.); a wine (red, white, rosé, dessert, fortified, etc.); or a beer (ale, lager, etc.). As different types of alcohol have differing percentages of alcohol and water, formulations may need to be adjusted to produce a final food product having a desired (or legally dictated) final percent alcohol-by-volume (ABV), while also accounting for the final water activity of the food product so as to maintain log-term shelf storage without risk of spoilage. Care should be taken to ensure that the temperature within the kettle does not exceed about 120 °F as this may cause the chocolate to seize. Additionally, mixing/stirring of the chocolate base is required to avoid the formation of localized heating within the kettle which may cause the ethanol to volatilize and evaporate. The alcohol may then be incorporated within the chocolate base while maintaining the temperature between about 100 °F and about 120 °F.

In an exemplary embodiment, an immersion blender is used to incorporate the alcohol into the chocolate base to form the alcohol infused chocolate food product. While stirring may enable the alcohol to become mixed within the chocolate base, it has been found that phase separation will occur whereby a layer of alcohol will form atop the chocolate base, particularly during storage. Without being limited to any one theory, it is believed that the immersion blender sufficiently disperses/distributes the alcohol within the chocolate base such that the alcohol is infused within the chocolate whereby phase separation is minimized, and preferably eliminated. That is, the hydrophilic moieties within the chocolate are able to sequester the alcohol and prevent hydrophobic/hydrophilic phase separation. In one embodiment, the immersion blender may infuse the alcohol while the alcohol is being added to the chocolate base. Alternatively, the immersion blender may be operated following the completed addition of the alcohol. In either event, blending continues until alcohol infusion is completed, such as confirmed via visual inspection. Care should also be taken to avoid the introduction of air into the food product.

The alcohol infused chocolate food product is then stirred using the kettle mixer (not blended via the immersion blender) while maintaining a temperature of between about 100 °F and about 120 °F, and more particularly between about 110 °F and about 115 °F, to produce a final product having a generally free-flowing consistency for dispensing and/or packaging of the alcohol infused chocolate food product. By way of example and without limitation, the smooth consistency of the alcohol infused chocolate food product may have a consistency similar to that of a fudge or putty at room temperature, and may have a viscosity of at least 150,000 centipoise (cps), and in a preferred embodiment at least 1,000,000 cps, and in a further preferred embodiment at least 5,000,000 cps at room temperature (about 65 °F to about 75 °F). Alternative embodiments of the present invention may include an alcohol infused chocolate food product having a viscosity less than 150,000 cps at room temperature and be of a form and consistency similar to a syrup or other pourable food product.

To assist dispensing, the kettle may be pressurized or equipped with a pump. Alternatively, the alcohol infused chocolate food product may be transferred to another vessel in bulk for dispensing via a pump or pressure. It is noted that any suitable packaging may be used to hold the food product. In one embodiment, the alcohol infused chocolate food product is dispensed into a container, and in preferred embodiments, within a sealable glass container, and more preferably with minimal voided headspace within the sealed container.

It is further contemplated that, while the alcohol infused chocolate food product may be consumed as a viscous fudge/putty as described above, additional embodiments may utilize the alcohol infused chocolate food product in further process steps. By way of example and without limitation, the alcohol infused chocolate food product may be further thinned to flow similar to a chocolate syrup, may be coated with a solid chocolate or candy shell, or may be incorporated within another finished product such as a cake, cookie or ice cream.

In one aspect of the invention, the water activity of the final alcohol infused chocolate food product should be less than 0.85 to prevent harmful growth of pathogens within the food product, particularly over long-term storage (e.g., greater than 6 months). As described above, it is critical to control the amount of water or other sources of moisture used in preparing the final food product to ensure that the water activity is less than 0.85. It has been found that a glass container maintains the finalized food product at the desired consistency, while also maintaining the alcohol content at the desired percentage and the water activity at less than 0.85. In one exemplary embodiment, the alcohol infused chocolate food product has an alcohol-by-volume (ABV) percentage of at least two percent (2%). Additionally or alternatively, the alcohol infused chocolate food product may have an ABV percentage of less than five percent (5%).

The present invention contemplates that many changes and modifications may be made. Therefore, while one or more embodiments of the improved structure and method for environmentally friendly blister packaging have been shown and described, and a number of alternatives discussed, persons skilled in this art will readily appreciate that various additional changes and modifications may be made without departing from the spirit of the invention, as defined and differentiated by the following claims.

What is claimed is:

1. A method of making a chocolate food product, the method comprising:
a) preparing a chocolate base comprising chocolate and milk;
b) maintaining the chocolate base at a first temperature between about 100 °F and about 120 °F while stirring;
c) adding an alcohol to the chocolate base while maintaining the first temperature; and
d) incorporating the alcohol within the chocolate base while maintaining the first temperature to form the alcohol infused chocolate food product.

2. The method of claim 1 wherein the chocolate comprises at least 50% cocoa solids by weight.

3. The method of claim 1 wherein the milk comprises one or more of whole milk, cream, evaporated milk, dried milk, or sweetened condensed milk.

4. The method of claim 1 wherein the chocolate base further comprises vanilla.

5. The method of claim 4 wherein the vanilla is one or more of: i) a real vanilla extract, a real vanilla powder, or a real vanilla paste, or ii) an artificial vanilla extract, an artificial vanilla powder, or an artificial vanilla paste.

6. The method of claim 1 wherein incorporating the alcohol is via an immersion blender.

7. The method of claim 1 wherein the alcohol is a spirit, a wine, or a beer.

8. The method of claim 1 further comprising dispensing of the alcohol infused chocolate food product into a sealable container.

9. The method of claim 1 wherein the milk is sweetened condensed milk comprising at least 50% by weight of the alcohol infused chocolate food product.

10. The method of claim 1 wherein the alcohol infused chocolate food product has an alcohol-by-volume percentage of at least two percent (2%).

11. The method of claim 1 wherein the alcohol infused chocolate food product has an alcohol-by-volume percentage of less than five percent (5%).

12. The method of claim 1 wherein step d) occurs sequentially or simultaneously with step c) and is maintained until the alcohol infused chocolate food product reaches a smooth consistency without separation of the alcohol from the chocolate base.

13. The method of claim 1 wherein the alcohol infused chocolate food product has a water activity less than 0.85.

14. A method of making an alcohol-infused chocolate food product, the method comprising:
a) preparing a chocolate base comprising chocolate and milk;
b) maintaining the chocolate base at a first temperature between about 100 °F and about 120 °F while stirring;
c) adding an alcohol to the chocolate base while maintaining the first temperature;
d) blending, via an immersion blender, the alcohol within the chocolate base while maintaining the first temperature until the alcohol is incorporated within the chocolate base without phase separation of the alcohol;
e) stirring the blended alcohol and chocolate base to form the alcohol-infused chocolate food product while maintaining the first temperature;
f) dispensing the alcohol-infused chocolate food product into a container; and
g) allowing the alcohol-infused chocolate food product to cool to room temperature,
wherein the cooled alcohol-infused chocolate food product has a water activity less than 0.85 and a viscosity greater than about 150,000 centipoise (cps), and
wherein the container is configured for shelf storage of at least six months.

15. The method of claim 14 wherein the chocolate comprises at least 50% cocoa solids by weight.

16. The method of claim 14 wherein the milk comprises one or more of whole milk, cream, evaporated milk, dried milk, or sweetened condensed milk.

17. The method of claim 14 wherein the chocolate base further comprises vanilla.

18. The method of claim 17 wherein the vanilla is one or more of: i) a real vanilla extract, a real vanilla powder, or a real vanilla paste, or ii) an artificial vanilla extract, an artificial vanilla powder, or an artificial vanilla paste.

19. The method of claim 14 wherein step d) occurs sequentially or simultaneously with step c) and is maintained until the alcohol infused chocolate food product reaches a smooth consistency without separation of the alcohol from the chocolate base.

20. The method of claim 19 wherein the alcohol is added to the chocolate base stepwise in aliquots wherein a subsequent aliquot is added after the previous aliquot has been incorporated.
